(19) United States
(12) Patent Application Publication
(10) Pub. No.: US 2021/0158338 A1
(43) Pub. Date: May 27, 2021

(54) METHOD FOR INDEXING DOMAIN TO DIGITAL ASSET

(71) Applicant: Chung Jong LEE, Gangwon-do (KR)

(72) Inventors: Chung Jong LEE, Gangwon-do (KR); Seung Jun SONG, Bucheon-si Gyeonggi-do (KR)

(21) Appl. No.: 17/047,765

(22) PCT Filed: Apr. 19, 2019
(86) PCT No.: PCT/KR2019/004783

§ 371 Date: Oct. 15, 2020

(30) Foreign Application Priority Data
Apr. 20, 2018 (KR) 10-2018-0046172
Apr. 17, 2019 (KR) 10-2019-0045114

(51) Int. Cl. G06Q 20/36; G06Q 20/06; G06Q 20/38; H04L 29/12

(52) U.S. Cl. CPC G06Q 20/3674; G06Q 20/3672; G06Q 20/0658; G06Q 30/018; G06Q 20/388; H04L 61/302; G06Q 20/3678

(57) ABSTRACT

A method for indexing a domain to a digital asset by a registrar server includes the steps of: (a) receiving, by the registrar server, a request for registration of a domain entity from a client of an owner or an expectant owner of a domain; and (b) requesting, by the registrar server, registration of the whole or part of the domain entity to a registry server, wherein, in step (a), the domain entity includes an address of the domain or information on a digital asset held by the owner or the expectant owner of the domain, and the information on the digital asset is cryptocurrency holding information in which trading records of digital tokens are encrypted and connected to node servers through a network having a blockchain structure. Therefore, a user of a website can easily recognize the actual asset size of an operator of the website.

### BACKGROUND OF THE DISCLOSURE

### Field of the Disclosure

The present invention relates to a method of indexing a domain to a digital asset and, more particularly, to a method of indexing a domain to a digital asset, wherein the size of a digital asset owned by a domain name owner who operates a website or basic information and financial information of a company is included in domain registration information which can be easily searched for by everyone and announced publicly, so a website user can easily check the size of the digital asset owned by the domain name owner or the basic information and financial information of the company by searching a registry or a registrar for the registration information of a corresponding domain, and domain name ownership and website operation expenses are paid with a digital asset connected to the domain registration information so that the website can be stably operated.

### Related Art

In order to access a website, a user uses a uniform resource locator (URL) or a domain name associated with a site. The domain name is a limited resource on the Internet. A specific domain name can be occupied by only one owner, and only the owner may operate a website.

The domain name may be occupied by registering a domain entity, such as a domain name, an owner, or a name server, with a registry. In general, a domain entity is registered by requesting a registry to register the domain entity with a registrar capable of doing the registration of the domain entity by proxy.

Anyone can find the domain name owner who operates a website connected through a domain name easily, by visiting a registry or registrar site and querying domain registration information. However, the domain name may be registered at a relatively cheap cost. The asset size of the domain name owner may be estimated only based on an index, such as the number of visitors and awareness. There is no means which enables a user using a website to check a substantial asset size of a website operating entity.

In the modern society in which cases where a shopping mall is operated through a website, the settlement of contracts for providing various services is induced, business to be carried forward by a company is promoted, and investors are recruited are frequent, if a website user purchases a product based on only advertising information on a website, concludes a service provision contract, or determines investment without checking a substantial asset size of a website operating entity, the website user may sustain great damage due to sudden closing of the website of the website operating entity.

If a website operating entity is a listed company, any investor may check a substantial asset size of a website operating entity through the corporate disclosure system through which a company fully publicly announces information of its enterprise contents necessary for a determination of investment in its stocks, that is, important enterprise contents which may have a great influence on the stock price of the company, such as business performance, a financial position, merger, and increase of capital, so an investor may make an investment decision his or her own free decision and responsibility by accurately checks the true nature of the company, thus contributing efficiency of a resource distribution through a stock market.

An unlisted company may also publicly announce information in order for the value of its properties to be evaluated, but this is not compulsory. In the case of a website operated by small business or an individual business person, a user cannot check a substantial asset size of a website operating entity. Accordingly, there is a need for a system through which a website user can easily check a substantial asset size of a website operating entity.

Meanwhile, in the case of a blockchain-based cryptocurrency and digital token whose trading records are distributed and maintained in a network of distributed nodes, there is a website which announces publicly an issued volume, the amount of currency, etc. However, it is difficult to easily find a website operated by an entity that issues a corresponding cryptocurrency or digital token. There are many cases where the operation of a website operated by an entity that issues a corresponding cryptocurrency or digital token is stopped due to a management mistake or a sudden increase of traffic.

Anyone can issue digital tokens by paying a given cost only. A case where an entity who issued corresponding digital tokens disappears without carrying out subsequent business, after receiving the investment through initial coin offering (ICO) is frequent. In order to prevent such damage, there is a need for a system through which a person who tries to invest in the issue of cryptocurrency or digital tokens or purchase cryptocurrency or digital tokens can easily check website information and asset size of an entity who issues the corresponding cryptocurrency or digital token.
(Patent Document 1) Korean Patent No. 10-1628007 (Jun. 13, 2016)
(Patent Document 2) Korean Patent No. 10-1628009 (Jun. 13, 2016)

### SUMMARY OF THE DISCLOSURE

An object of the present invention is to enable a website user to easily check a substantial asset size of a website operating entity and to easily check the size of a digital asset owned by a domain name owner or basic information and financial information of a company by searching a registry or a registrar for registration information of a corresponding domain although the operation of the website is temporarily stopped, in such a manner that the domain name owner who operates the website publicly announces the size of the own digital asset or the basic information and financial information of the company by including them in the domain registration information which can be easily searched for by everyone.

Furthermore, an object of the present invention is to enable an extended registration fee of a domain, a traffic cost, and various domain-based services costs to be paid within a digital asset range of a domain owner because domain name ownership and an operating fee are paid with a digital asset connected to domain registration information and to enable the ownership and operation of a domain to be continuously maintained because such expense payment is performed without the authentication of additional payment information.

In order to achieve the objects, the present invention provides a method of indexing, by a registrar server, a domain to a digital asset, including the steps of (a) receiving, by the registrar server, a request for a registration of a domain entity from a client of an owner or owner-to-be of a domain; and (b) requesting, by the registrar server, a registration of part of or the entire domain entity to a registry server, wherein in the step (a), the domain entity whose registration has been requested by the client comprises at least one of an address of the domain or digital asset information owned by the owner or owner-to-be of the domain, and the digital asset information is holding information of cryptocurrency whose trading records of digital tokens are encrypted and connected to node servers over a network having a blockchain structure.

Furthermore, the present invention provides a method of indexing, by a registry server, a domain to a digital asset, including the steps of (a) receiving, by the registry server, a request for a registration of a domain entity from a registrar server; and (b) recording, by the registry server, the requested registration of the domain entity in a database of the registry server, wherein in the step (a), the domain entity whose registration has been requested by the registrar server comprises an address of a domain or digital asset information owned by an owner or owner-to-be of the domain, and the digital asset information is holding information of cryptocurrency whose trading records of digital tokens are encrypted and connected to node servers over a network having a blockchain structure.

### Advantageous Effects

According to the method of indexing a domain to a digital asset according to the present invention, a domain name owner who operates a website publicly announces the size of its own digital asset or basic information and financial information of a company by including them in domain registration information which can be easily searched for by everyone. Accordingly, there are effects in that a website user can easily check a substantial asset size of a website operating entity and easily check the size of a digital asset owned by a domain name owner or basic information and financial information of a company by searching a registry or a registrar for the registration information of a corresponding domain although the operation of the website is temporarily stopped.

Furthermore, there are effects in that an extended registration fee of a domain, a traffic cost, and various domain-based services costs can be paid within a digital asset range of a domain owner because domain name ownership and an operating fee are paid with a digital asset connected to domain registration information and the ownership and operation of a domain can be continuously maintained because such expense payment is performed without the authentication of additional payment information.

### BRIEF DESCRIPTION OF THE DRAWINGS

FIG. 1 illustrates a registrar server and elements connected thereto according to an aspect of the present invention.

FIG. 2 illustrates a method of indexing, by the registrar server, a domain to a digital asset according to an aspect of the present invention.

FIG. 3 illustrates a method of indexing, by the registrar server, a domain to a digital asset according to an aspect of the present invention.

FIG. 4 illustrates a method of indexing, by the registrar server, a domain to a digital asset according to another aspect of the present invention.

FIG. 5 illustrates a method of indexing, by the registrar server, a domain to a digital asset according to another aspect of the present invention.

FIG. 6 illustrates a method of indexing, by the registrar server, a domain to a digital asset according to another aspect of the present invention.

FIG. 7 illustrates a method of indexing, by the registrar server, a domain to a digital asset according to an aspect of the present invention.

FIG. 8 illustrates a method of indexing, by the registrar server, a domain to a digital asset according to an aspect of the present invention.

FIG. 9 illustrates a method of indexing, by the registrar server, a domain to a digital asset according to another aspect of the present invention.

FIG. 10 illustrates a method of indexing, by the registrar server, a domain to a digital asset according to another aspect of the present invention.

FIG. 11 is an example in which a requested domain entity is received and displayed in a client in the method of indexing, by the registry server, a domain to a digital asset according to the present invention.

FIG. 12 illustrates a registry server and elements connected thereto according to an aspect of the present invention.

FIG. 13 illustrates a method of indexing, by the registry server, a domain to a digital asset according to an aspect of the present invention.

FIG. 14 illustrates a method of indexing, by the registry server, a domain to a digital asset according to an aspect of the present invention.

FIG. 15 illustrates a method of indexing, by the registry server, a domain to a digital asset according to an aspect of the present invention.

FIG. 16 illustrates a method of indexing, by the registry server, a domain to a digital asset according to an aspect of the present invention.

FIG. 17 illustrates a method of indexing, by the registry server, a domain to a digital asset according to an aspect of the present invention.

FIG. 18 illustrates a method of indexing, by the registry server, a domain to a digital asset according to an aspect of the present invention.

FIG. 19 illustrates a method of indexing, by the registry server, a domain to a digital asset according to an aspect of the present invention.

FIG. 20 illustrates a method of indexing, by the registry server, a domain to a digital asset according to an aspect of the present invention.

### DESCRIPTION OF EXEMPLARY EMBODIMENTS

According to an aspect of the present invention, there is proposed a method of indexing, by a registrar server, a domain to a digital asset, including the steps of (a) receiving, by the registrar server, a request for a registration of a domain entity from a client of an owner or owner-to-be of a domain; and (b) requesting, by the registrar server, a registration of part of or the entire domain entity to a registry server, wherein in the step (a), the domain entity whose registration has been requested by the client comprises at least one of an address of the domain or digital asset information owned by the owner or owner-to-be of the domain, and the digital asset information is holding information of cryptocurrency whose trading records of digital tokens are encrypted and connected to node servers over a network having a blockchain structure.

The terms used in this specification are used to only describe specific embodiments and are not intended to restrict the present invention. An expression of the singular number should be construed as including an expression of the plural number unless clearly defined otherwise in the context. It is to be understood that in this application, a term, such as “include (or comprise)” or “have”, is intended to designate that a characteristic, number, step, operation, element or part which is described in the specification or a combination of them are present and does not exclude the existence or possible addition of one or more other characteristics, numbers, steps, operations, elements, parts or combinations of them in advance.

All terms used herein, including technical terms or scientific terms unless defined otherwise in the specification, have the same meanings as those commonly understood by a person having ordinary skill in the art to which the present invention pertains. Terms, such as those commonly used and defined in dictionaries, should be construed as having the same meanings as those in the context of a related technology, and should not be construed as having ideal or excessively formal meanings unless explicitly defined otherwise in the specification. The same reference numerals described in drawings refer to the same elements. However, in describing the embodiments, a detailed description of the known function or element related to the present invention will be omitted if it is deemed to make the gist of the present invention unnecessarily vague. Furthermore, it is to be noted that in the drawings, the size of each element may have been exaggerated and does not correspond to an actual size.

An embodiment described in this specification may have an aspect that is entirely hardware, an aspect that is partially hardware and partially software, or an aspect that is entirely software. In this specification, a “unit”, a “module”, a “device” or a “system” denotes a computer-related entity, such as hardware, a combination of hardware and software, or software. For example, in this specification, a unit, a module, a device or a system may be a process being executed, a processor, an object, an executable file, a thread of execution, a program and/or a computer, but the present disclosure is not limited thereto. For example, both an application being executed in a computer and a computer may correspond to a unit, a module, a device or a system in this specification.

A method of the present invention is not limited to the sequence of the steps of each method, and some steps may be performed in a sequence different from or simultaneously with other blocks and a sequence illustrated and described in this specification, and sequences of various other branches, flow paths, and steps that achieve the same or similar results may be implemented. Furthermore, all steps illustrated for an implementation of a method described in this specification may not be necessary. Furthermore, a method according to an embodiment of the present invention may be implemented in the form of a computer program for performing a series of processes, and the computer program may be written in a computer-readable recording medium.

Hereinafter, elements and characteristics of the present invention are described using embodiments, but these embodiments merely illustrate the present invention and do not limit the present invention.

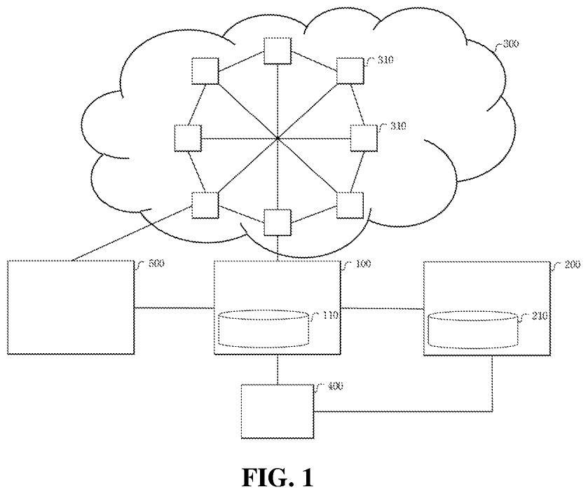

Hereinafter, a registrar server 100 and elements connected thereto according to the present invention are described with reference to FIG. 1. An unillustrated element may be understood based on a given description itself. Furthermore, an illustration of a network in FIG. 1 is an example, and the range of the network is not limited to the range in the drawing.

The registrar server 100 according to the present invention may include a database 110 for storing a domain entity or cryptocurrency trade information, and may be connected to an external database.

Furthermore, the registrar server 100 may be connected to at least one of a registry server 200, a network 300 having node servers 310 and a blockchain structure in which trading records of digital tokens are encrypted, a client 400 of the owner or owner-to-be of a domain, and a cryptocurrency transaction intermediation server 500.

In the present invention, a “blockchain” may mean a distributed computing storage method in which partial data to be stored, having a “block” unit, is stored in a distributed data storage environment in a chain form generated based on a peer to peer (P2P) method.

In the present invention, a “node” may mean a server of elements configuring the network having the blockchain structure in which all of block unit partial data or storage target data chains are stored.

In the present invention, “cryptocurrency” may mean currency using a digital method, whose issue and trading records are distributed and stored in the network having the blockchain structure.

Cryptocurrency connected over the network having the blockchain structure according to the present invention may be blockchain-based cryptocurrency having a form capable of implementing embodiments of the present invention or may be cryptocurrency modified in a form capable of implementing embodiments of the present invention in the existing blockchain platform.

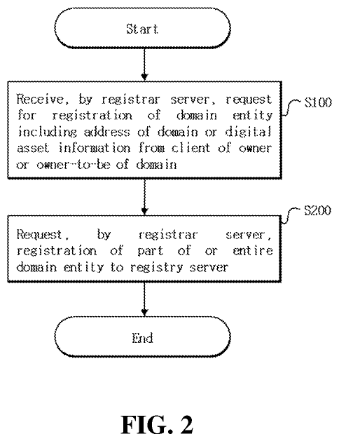

Hereinafter, a method of indexing, by the registrar server 100, a domain to a digital asset according to the present invention is described with reference to FIG. 2. In the present invention, the aforementioned description of the registrar server 100 may be applied unless described otherwise.

The method of indexing, by the registrar server 100, a domain to a digital asset may include the step S100 of receiving, by the registrar server 100, a request for the registration of a domain entity, including the address of a domain or digital asset information, from the client 400 of the owner or owner-to-be of the domain, and

the step S200 of requesting, by the registrar server 100, the registration of part of or the entire domain entity to a registry server.

The domain entity may include the address of the domain or the digital asset information, and may include both the address of the domain and the digital asset information.

The domain entity may include domain name system (DNS) information, and may include a domain name, a name server name, and a name server Internet protocol (IP) number, for example.

Furthermore, the domain entity may further include basic information of a company, that is, the owner or owner-to-be of the domain.

The basic information of a company is information, including both information that must be open to the public by a listed company according to the corporate disclosure system and information which may be open to the public by an unlisted company in order for the value of its properties to be evaluated. The basic information of the company may include information on the name, logo, name of a representative, date of establishment, form of business, corporate registration number, corporate body registration number, total assets, total ownership interest, total liability, total sales, business profits, net income, principal stockholders and board of directors of the company.

Such basic information of a company, that is, the owner of a domain or the owner-to-be of the domain may be preferably configured to be continuously updated through interoperation with a registry or a registrar or an external site.

Furthermore, the domain entity may further include financial information of a company, that is, the owner or owner-to-be of a domain. Such financial information includes a company's financial statements and the outcome of a company's business activities.

The financial statements are information on a flow of funds occurring in a business process of a company, and is a ready reckoner produced by periodically settling the accounts of business performance in terms of funds based on accounting information recorded according to a given principle.

Such financial statements include the balance sheet, the statement of comprehensive income, the statement of cash flow, the statement of changes in equity, and the statement of appropriation of retained earnings. Furthermore, in the case of manufacturing business, the financial statements additionally include the statement of the costs of goods manufactured as specifications annexed to financial statements.

The balance sheet is a table indicative of a financial position of a company at given timing. The balance sheet includes an asset, debt, and capital.

The statement of comprehensive income is a table indicative of business performance of a company for a given period. The statement of comprehensive income includes a profit and cost, a net profit, and profit and loss results of a company.

The statement of cash flow is indicated by dividing the inflow and outflow of cash of a company for a given period into business activities, investing activities, and financing activities. The statement of cash flow includes an increase or decrease of cash, starting cash, and ending cash.

The statement of changes in equity is financial reports that provide information on the size and change of capital. The statement of changes in equity includes comprehensive information on a change in capital, a capital surplus, capital adjustment, an accumulated other comprehensive income, and an earned surplus forming capital.

The statement of appropriation of retained earning indicates disposal contents of an earned surplus, and indicates how much has an earned surplus prior to disposal been disposed as a dividend, a legal reserve, and a voluntary reserve.

The statement of the costs of goods manufactured indicates detailed information on product costs completed during the term, such as a direct material cost, a direct labor cost, and manufacturing overhead expenses, and includes important information of analysis in the case of manufacturing business.

The digital asset information may be holding information of cryptocurrency whose trading records of digital tokens are encrypted and connected to the node servers over the network having the blockchain structure.

In the present invention, a “digital token” may mean a digital asset which may be traded over the network having the blockchain structure.

The registration of a domain entity may be the new registration of a corresponding domain address or the update of related information of a corresponding domain address.

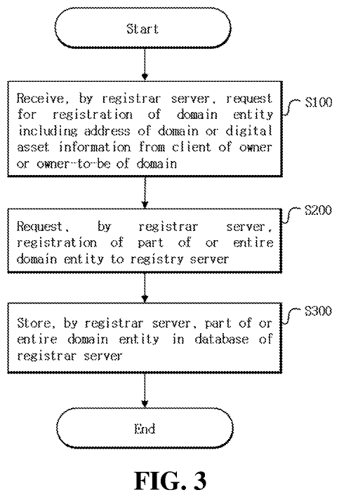

Referring to FIG. 3, the method of indexing a domain to a digital asset may further include the step S300 of storing, by the registrar server 100, part of or the entire domain entity in the database 110 of the registrar server 100.

Holding information of the cryptocurrency may include an asset ID of a cryptocurrency wallet or a private key value to which a deposit and withdrawal authority has been assigned. The asset ID may be a value on which a digital token is identifiable on the blockchain network. The private key may be an authentication value on which a digital token of a cryptocurrency wallet may be deposited and withdrawn on the blockchain network. The asset ID or the private key are finally stored in the database 210 of the registry server 200 or the database 110 of the registrar server 100, and allows information, such as the balance of a cryptocurrency wallet, to be read through access to a blockchain system. The asset ID or the private key may enable a corresponding cost to be paid with a digital token based on update timing of domain owner information.

The holding information of the cryptocurrency may include an application programming interface (API) key value to which the deposit and withdrawal authority of a cryptocurrency wallet has been assigned. The asset ID a value on which a digital token is identifiable on the blockchain network. The API key may be an authentication value on which the deposit and withdrawal function of a digital token in a cryptocurrency wallet may be revoked on the blockchain network. The API key is finally stored in the database 210 of the registry server 200 or the database 110 of the registrar server 100, and enables information, such as the balance of a cryptocurrency wallet, to be read through access to the blockchain system. The API key may enable a corresponding cost to be paid with a digital token based on update timing of domain owner information.

The holding information of the cryptocurrency may include a private key value or API key value having a limited withdrawal authority for a cryptocurrency wallet. The asset ID or API key having the limited withdrawal authority may enable a digital asset owned by a domain owner to be announced publicly. Accordingly, a digital asset owned by an entity that owns a domain may function as capital of a corporation.

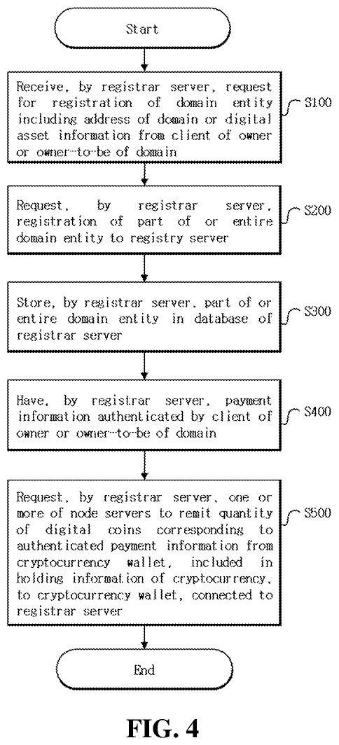

Referring to FIG. 4, the method of indexing a domain to a digital asset may further include the step S400 of having, by the registrar server 100, payment information authenticated by the client 400 of the owner or owner-to-be of the domain; and the step S500 of requesting, by the registrar server 100, one or more of the node servers 310 to remit a quantity of digital coins corresponding to the authenticated payment information from the cryptocurrency wallet, included in the holding information of the cryptocurrency, to the cryptocurrency wallet connected to the registrar server 100. Through the execution of such steps, expense payment for an entity, such as a registrar, can be processed with the digital asset of a corresponding domain even without an additional procedure of identifying payment information.

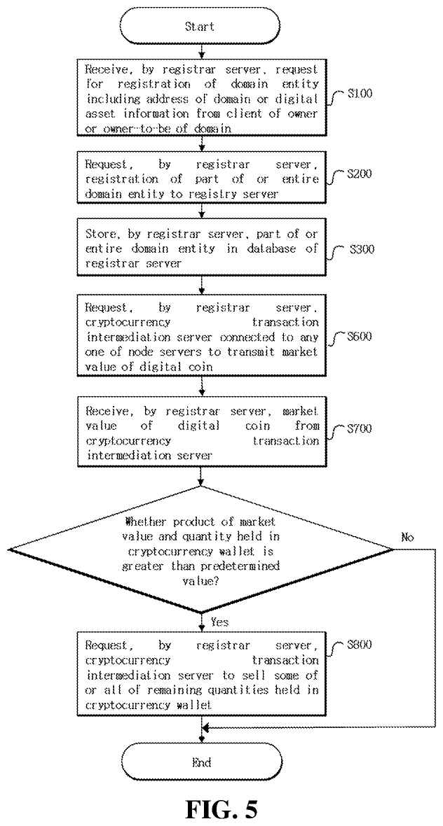

Referring to FIG. 5, the method of indexing a domain to a digital asset may further include the step S600 of requesting, by the registrar server 100, the cryptocurrency transaction intermediation server 500 connected to any one of the node servers 310 to transmit a market value of the digital coin; the step S700 of receiving, by the registrar server 100, the market value of the digital coin from the cryptocurrency transaction intermediation server; and the step S800 of requesting, by the registrar server 100, the cryptocurrency transaction intermediation server 500 to sell some of or all of the remaining quantities held in the cryptocurrency wallet, when the product of the market value and the quantity held in the cryptocurrency wallet is greater than a predetermined value. Through the execution of such steps, if a digital asset deposited in a corresponding domain exceeds a predetermined quantity, a coin for the digital asset can be listed in a cryptocurrency exchange.

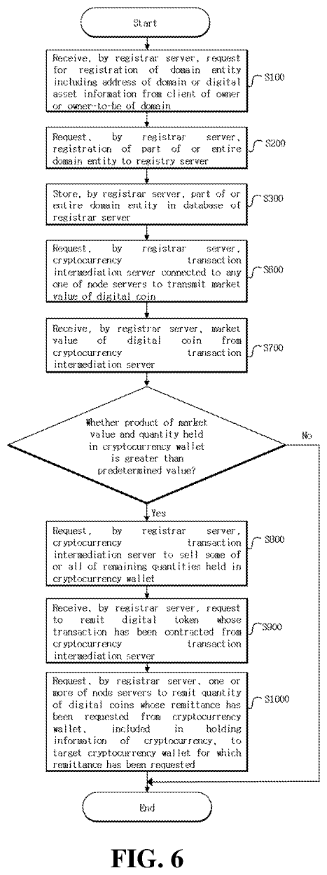

Referring to FIG. 6, the method of indexing a domain to a digital asset may further include the step S900 of receiving, by the registrar server 100, a request to remit a digital token whose transaction has been contracted from the cryptocurrency transaction intermediation server 500; and the step S1000 of requesting, by the registrar server 100, one or more of the node servers 310 to remit the quantity of the digital coins whose remittance has been requested from the cryptocurrency wallet, included in the holding information of the cryptocurrency, to a target cryptocurrency wallet for which the remittance has been requested. Through the execution of such steps, when a digital asset deposited in a corresponding domain exceeds a predetermined quantity, the transactions of a listed coin can be performed by requesting the listing of the requested coin from a cryptocurrency exchange.

The method of indexing a domain to a digital asset may further include the step S1100 of storing, by the registrar server 100, the trading record of the digital coin whose remittance has been requested in the database 110 of the registrar server 100.

The holding information of the cryptocurrency may be an address value of the cryptocurrency wallet. The address value is finally stored in the database 210 of the registry server 200 or the database 110 of the registrar server 100, and enables information, such as the balance of the cryptocurrency wallet, to be read through access to the blockchain system.

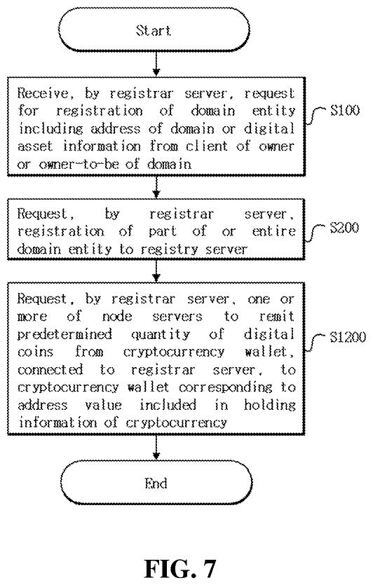

Referring to FIG. 7, the method of indexing a domain to a digital asset may further include the step S1200 of requesting, by the registrar server 100, one or more of the node servers 310 to remit a predetermined quantity of digital coins from the cryptocurrency wallet, connected to the registrar server 100, to a wallet corresponding to an address value of the cryptocurrency wallet. Through the execution of such steps, expense payment for an entity, such as a registrar, can be processed as the digital asset of a corresponding domain even without an additional procedure of identifying payment information.

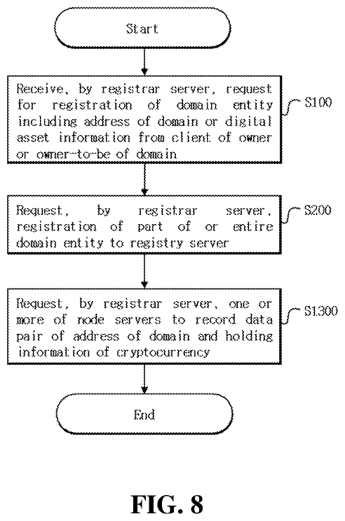

Referring to FIG. 8, the method of indexing a domain to a digital asset may further include the step S1300 of requesting, by the registrar server 100, one or more of the node servers 310 to record a data pair of the address of the domain and the holding information of the cryptocurrency. The data pair enables a correlation between a domain and a digital token to be distributed and stored in a blockchain. Specifically, the data pair may be written in the attachment of the trading record of a digital token.

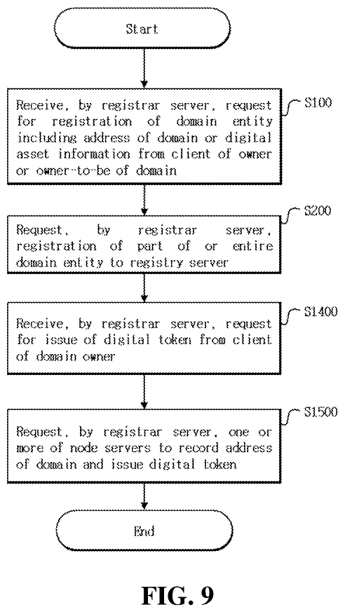

Referring to FIG. 9, the method of indexing a domain to a digital asset may further include the step S1400 of receiving, by the registrar server 100, a request for the issue of digital tokens from the client 400 of the domain owner; and the step S1500 of requesting, by the registrar server 100, one or more of the node servers 310 to record the address of the domain and issue the digital tokens. Through the execution of such steps, a digital coin can be issued along with the registration of a corresponding domain name, and the digital coin can be distributed to the owner of the digital coin issued in the corresponding domain name.

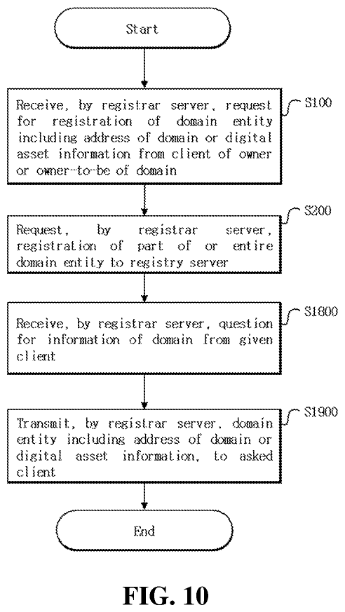

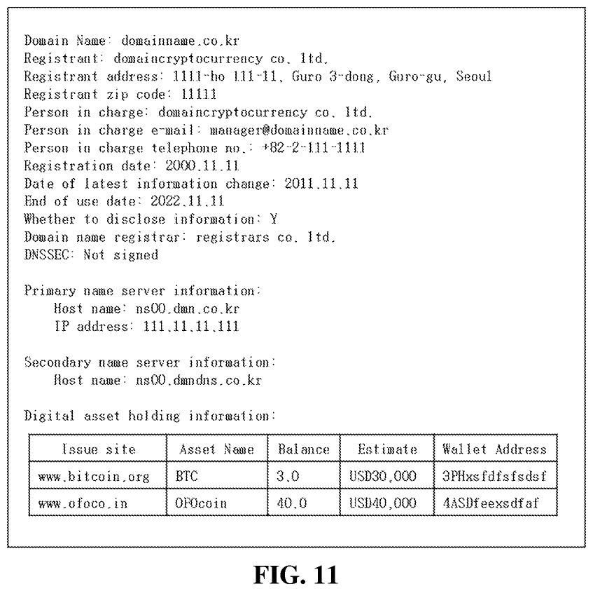

Referring to FIG. 10, the method of indexing a domain to a digital asset may further include the step S1800 of receiving, by the registrar server 100, a question for information of the domain from a given client; and the step S1900 of transmitting, by the registrar server 100, a domain entity, including the address of the domain or the digital asset information, to the asked client 400. Through the execution of such steps, information on a digital asset deposited in a corresponding domain, specifically, the domain name of an entity who issues a digital token, an asset ID, the address of cryptocurrency wallet, the quantity of digital tokens owned by a domain owner can be announced publicly. An example in which the client 400 receives and displays a requested domain entity may be the same as that of FIG. 11.

The holding information of the cryptocurrency may be the holding information of at least one type of the cryptocurrency. Furthermore, holding information of a digital token may also be the holding information of at least one type of a digital token.

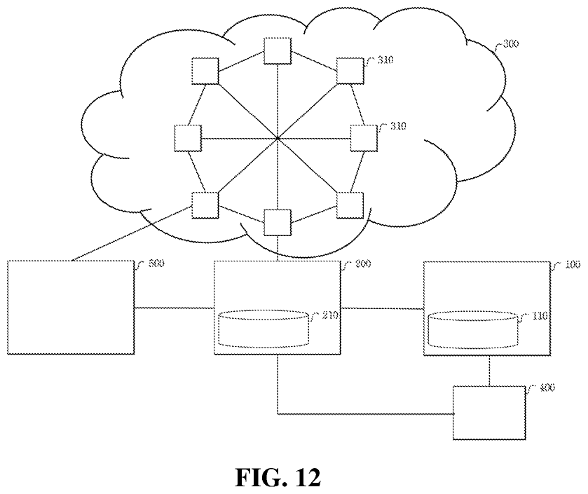

Hereinafter, a registry server 200 according to the present invention and elements connected thereto are described with reference to FIG. 12. An unillustrated element may be understood based on a given description itself. Furthermore, an indication of a network in FIG. 12 is an example, and the range of the network is not limited to the range of the drawing.

The registry server 200 according to the present invention may include a database 210 for storing a domain entity or cryptocurrency trade information or may be connected to an external database.

Furthermore, the registry server 200 may be connected to at least one of a registrar server 100, a network 300 having node servers 310 and a blockchain structure in which trading records of digital tokens are encrypted, a client 400 of the owner or owner-to-be of the domain, and a cryptocurrency transaction intermediation server 500.

Hereinafter, a method of indexing, by the registry server 200, a domain to a digital asset according to the present invention is described. The aforementioned description of the registry server 200 may be applied to the present invention unless described otherwise. The aforementioned description of the method of indexing, by the registry server, a domain to a digital asset may be applied to the present invention unless defined otherwise.

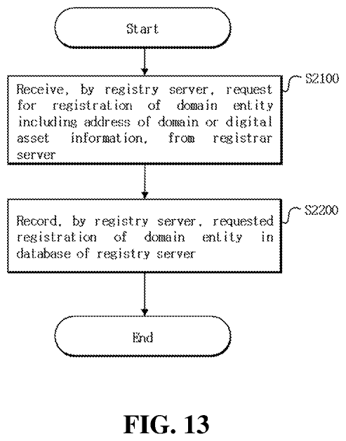

Referring to FIG. 13, the method of indexing, by the registry server 200, a domain to a digital asset may include the step S2100 of receiving, by the registry server 200, a request for the registration of a domain entity, including the address of a domain or digital asset information, from the registrar server 100; and the step S2200 of recording, by the registry server 200, the requested registration of the domain entity in the database 210 of the registry server 200.

The domain entity may include the address of the domain or the digital asset information, and may include both the address of the domain and the digital asset information.

The domain entity may include DNS information, and may include a domain name, a name server name, and a name server IP number, for example.

Furthermore, the domain entity may further include basic information of a company, that is, the owner or owner-to-be of the domain.

The basic information of a company is information, including both information that must be open to the public by a listed company according to the corporate disclosure system and information which may be open to the public by an unlisted company in order for the value of its properties to be evaluated. The basic information of the company may include information on the name, logo, name of a representative, date of establishment, form of business, corporate registration number, corporate body registration number, total assets, total ownership interest, total liability, total sales, business profits, net income, principal stockholders and board of directors of the company.

Such basic information of a company, that is, the owner or owner-to-be of the domain may be preferably configured to be continuously updated through interoperation with a registry or a registrar or an external site.

Furthermore, the domain entity may further include financial information of a company, that is, the owner or owner-to-be of a domain. Such financial information includes a company's financial statements and the outcome of a company's business activities.

The digital asset information may be holding information of cryptocurrency whose trading records of digital tokens are encrypted and connected to the node servers 310 over the network having the blockchain structure.

In the present invention, a “digital token” may mean a digital asset which may be traded over the network having the blockchain structure.

The registration of a domain entity may be the new registration of a corresponding domain address or the update of related information of a corresponding domain address.

Holding information of the cryptocurrency may include an asset ID of a cryptocurrency wallet or a private key value to which a deposit and withdrawal authority has been assigned. The asset ID may be a value on which a digital token is identifiable on the blockchain network. The private key may be an authentication value on which a digital token of a cryptocurrency wallet may be deposited and withdrawn on the blockchain network. The asset ID or the private key are finally stored in the database 210 of the registry server 200 or the database 110 of the registrar server 100, and allows information, such as the balance of a cryptocurrency wallet, to be read through access to a blockchain system. The asset ID or the private key may enable a corresponding cost to be paid with a digital token based on update timing of domain owner information.

The holding information of the cryptocurrency may include an API key value to which the deposit and withdrawal authority of a cryptocurrency wallet has been assigned. The asset ID a value on which a digital token is identifiable on the blockchain network. The API key may be an authentication value on which the deposit and withdrawal function of a digital token in a cryptocurrency wallet may be revoked on the blockchain network. The API key is finally stored in the database 210 of the registry server 200 or the database 110 of the registrar server 100, and enables information, such as the balance of a cryptocurrency wallet, to be read through access to a blockchain system. The API key may enable a corresponding cost to be paid with a digital token based on update timing of domain owner information.

The holding information of the cryptocurrency may include a private key value or API key value having a limited withdrawal authority for a cryptocurrency wallet. The asset ID or API key having the limited withdrawal authority may enable a digital asset owned by a domain owner to be announced publicly. Accordingly, a digital asset owned by an entity that owns a domain may function as capital of a corporation.

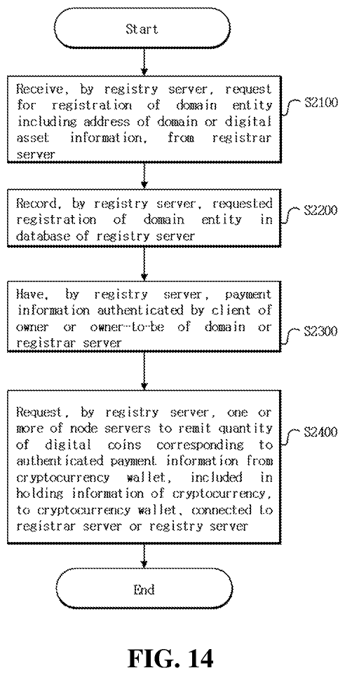

Referring to FIG. 14, the method of indexing a domain to a digital asset may further include the step S2300 of having, by the registry server 200, payment information authenticated by the client 400 of the owner or owner-to-be of the domain or the registrar server 100; and the step S2400 of requesting, by the registry server 200, one or more of the node servers 310 to remit a quantity of digital coins corresponding to the authenticated payment information from the cryptocurrency wallet included in the holding information of the cryptocurrency, to the cryptocurrency wallet, connected to the registrar server 100 or the registry server 200. Through the execution of such steps, expense payment for an entity, such as a registry, can be processed with the digital asset of a corresponding domain even without an additional procedure of identifying payment information.

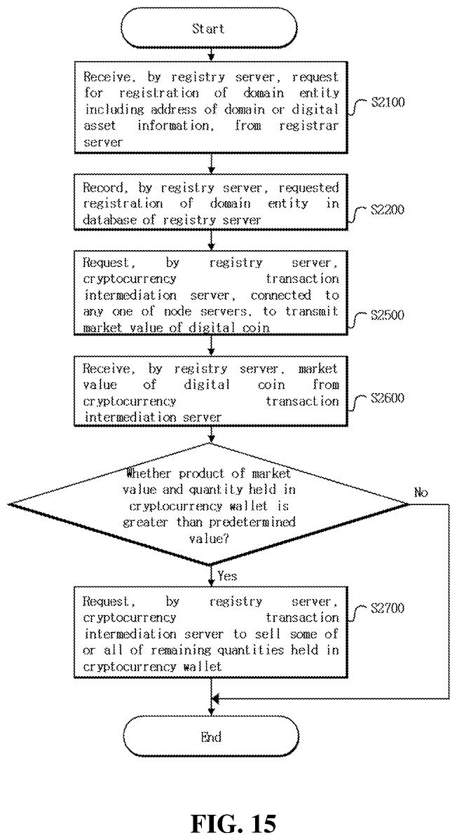

Referring to FIG. 15, the method of indexing a domain to a digital asset may further include the step S2500 of requesting, by the registry server 200, the cryptocurrency transaction intermediation server 500 connected to any one of the node servers 310 to transmit a market value of a digital coin, the step S2600 of receiving, by the registry server 200, the market value of the digital coin from the cryptocurrency transaction intermediation server 500; and the step S2700 of requesting, by the registry server 200, the cryptocurrency transaction intermediation server 500 to sell some of or all of the remaining quantities held in the cryptocurrency wallet when the product of the market value and the quantity held in the cryptocurrency wallet is greater than a predetermined value. Through the execution of such steps, if a digital asset deposited in a corresponding domain exceeds a predetermined quantity, a coin for the digital asset can be listed in a cryptocurrency exchange.

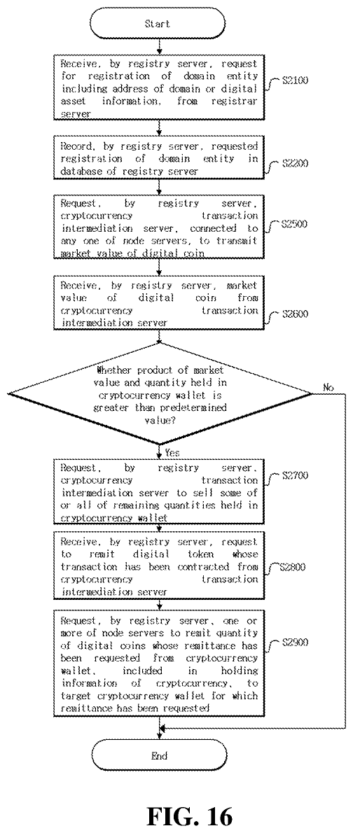

Referring to FIG. 16, the method of indexing a domain to a digital asset may further include the step S2800 of receiving, by the registry server 200, a request to remit a digital token whose transaction has been contracted from the cryptocurrency transaction intermediation server 500; and the step S2900 of requesting, by the registry server 200, one or more of the node servers 310 to remit the quantity of the digital coins whose remittance has been requested from the cryptocurrency wallet, included in the holding information of the cryptocurrency, to a target cryptocurrency wallet for which the remittance has been requested. Through the execution of such steps, when a digital asset deposited in a corresponding domain exceeds a predetermined quantity, the transactions of a listed coin can be performed by requesting the listing of the requested coin from a cryptocurrency exchange.

The method of indexing a domain to a digital asset may further include the step S3000 of storing, by the registry server 200, the trading record of the digital coin whose remittance has been requested in the database 210 of the registry server 200.

The holding information of the cryptocurrency may be an address value of the cryptocurrency wallet. The address value is finally stored in the database 210 of the registry server 200, and enables information, such as the balance of the cryptocurrency wallet, to be read through access to the blockchain system.

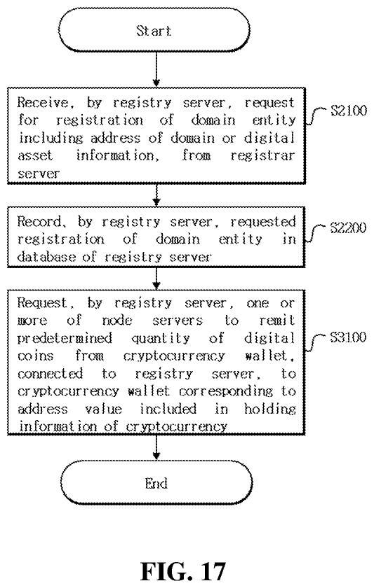

Referring to FIG. 17, the method may further include the step S3100 of requesting, by the registry server 200, any one of the node servers 310 to remit a predetermined quantity of digital coins from a wallet of cryptocurrency, connected to the registry server 200, to a wallet corresponding to an address value of the cryptocurrency wallet. Through the execution of such steps, expense payment for an entity, such as a registry, can be processed with the digital asset of a corresponding domain even without an additional procedure of identifying payment information.

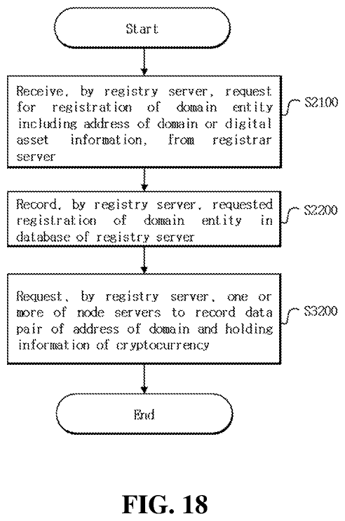

Referring to FIG. 18, the method of indexing a domain to a digital asset may further include the step S3200 of requesting, by the registry server 200, one or more of the node servers 310 to record a data pair of the address of the domain and holding information of the cryptocurrency. The data pair enables a correlation between a domain and a digital token to be distributed and stored in a blockchain. Specifically, the data pair may be written in the attachment of the trading record of a digital token.

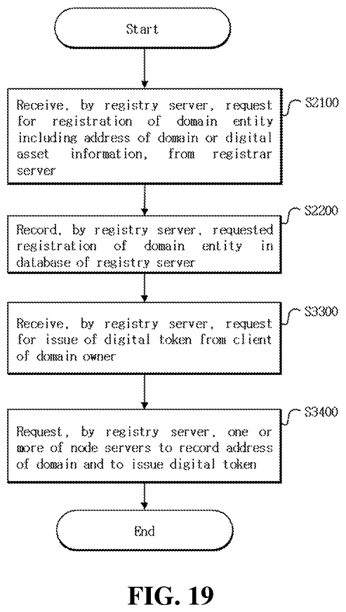

Referring to FIG. 19, the method of indexing a domain to a digital asset may further include the step S3300 of receiving, by the registry server 200, a request for the issue of digital tokens from the client 400 of the domain owner; and the step S3400 of requesting, by the registry server 200, one or more of the node servers 310 to record the address of the domain and to issue the digital tokens. Through the execution of such steps, a digital coin can be issued along with the registration of a corresponding domain name, and the digital coin can be distributed to the owner of the digital coin issued in the corresponding domain name.

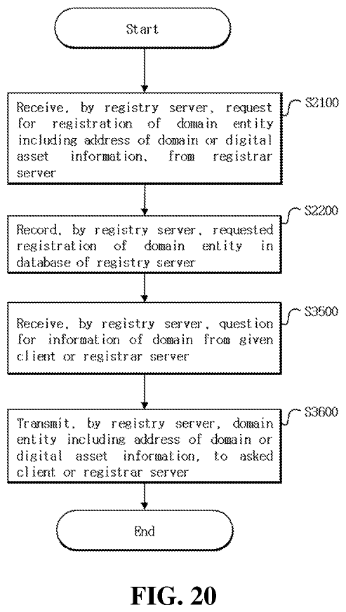

Referring to FIG. 20, the method of indexing a domain to a digital asset may further include the step S3500 of receiving, by the registry server 200, a question for information of the domain from a given client 600 or the registrar server 100; and the step S3600 of transmitting, by the registry server 200, the domain entity, including the address of the domain or the digital asset information, to the asked client 400 or the registrar server 100. Through the execution of such steps, information on a digital asset deposited in a corresponding domain, specifically, the domain name of an entity who issues a digital token, an asset ID, the address of cryptocurrency wallet, the quantity of digital tokens owned by a domain owner can be announced publicly. An example in which the client 400 receives and displays a requested domain entity may be the same as that of FIG. 11.

The holding information of the cryptocurrency may be the holding information of at least one type of the cryptocurrency. Furthermore, holding information of a digital token may also be the holding information of at least one type of a digital token.

Furthermore, the present invention may provide a program for performing each of the steps of the method of indexing a domain to a digital asset.

Furthermore, the present invention may provide a computer-readable recording medium in which the aforementioned program has been stored.

Although the present invention has been described in connection with specific matters, such as the detailed elements, and the limited embodiments and drawings, they have been provided only to help general understanding of the present invention, and the present invention is not limited to the embodiments. Those skilled in the art to which the present invention pertains may modify the embodiments in various ways from the above description.

Accordingly, the spirit of the present invention should not be limited and determined by the aforementioned embodiments, and all things modified equally or equivalently with the claims in addition to the claims may be said to fall within the category of the spirit of the present invention.

### DESCRIPTION OF REFERENCE NUMERALS

| | |
|---|---|
| 100: registrar server | 110: database |
| 200: registry server | 210: database |
| 300: network | 310: node server |
| 400: client | |
| 500: cryptocurrency transaction intermediation server | |

INDUSTRIAL AVAILABILITY

The present invention relates to a method of indexing a domain to a digital asset, and enables a website user to easily check a substantial asset size of a website operating entity and to easily check the size of a digital asset owned by a domain name owner or basic information and financial information of a company by searching a registry or a registrar for registration information of a corresponding domain although the operation of the website is temporarily stopped, in such a manner that the domain name owner who operates the website publicly announces the size of the own digital asset or the basic information and financial information of the company by including them in the domain registration information which can be easily searched for by everyone. The present invention may be used in fields, such as domain name ownership and website operation of a company.

1. A method of indexing, by a registrar server, a domain to a digital asset, the method comprising steps of:
(a) receiving, by the registrar server, a request for a registration of a domain entity from a client of an owner or owner-to-be of a domain; and
(b) requesting, by the registrar server, a registration of part of or an entire domain entity to a registry server;
wherein in the step (a), the domain entity whose registration has been requested by the client comprises at least one of an address of the domain or digital asset information owned by the owner or owner-to-be of the domain, and
the digital asset information is holding information of cryptocurrency whose trading records of digital tokens are encrypted and connected to node servers over a network having a blockchain structure.

2. The method of claim 1, wherein:
in the step (a), the domain entity whose registration has been requested by the client further comprises basic information of a company which is the owner or owner-to-be of the domain, and
the basic information is configured to comprise any one of pieces of information on a name, logo, name of a representative, date of establishment, form of business, corporate registration number, corporate body registration number, total assets, total ownership interest, total liability, total sales, business profits, net income, principal stockholders and board of directors of the company.

3. The method of claim 2, wherein:
in the step (a), the domain entity whose registration has been requested by the client further comprises financial information of the company which is the owner or owner-to-be of the domain, and
the financial information comprises company information for financial statements of the company and an output of business activities of the company.

4. The method of claim 1, further comprising a step of storing, by the registrar server, part of or the entire domain entity in a database of the registrar server.

5. The method of claim 1, wherein the holding information of the cryptocurrency comprises an asset ID of a cryptocurrency wallet or a private key value to which a deposit and withdrawal authority has been assigned.

6. The method of claim 1, wherein the holding information of the cryptocurrency comprises an API key value to which a deposit and withdrawal authority for a cryptocurrency wallet has been assigned.

7. The method of claim 1, wherein the holding information of the cryptocurrency comprises a private key value or an API key value having a limited withdrawal authority for a cryptocurrency wallet.

8. The method of claim 5, further comprising steps of:
having, by the registrar server, payment information authenticated by the client of the owner or owner-to-be of the domain; and
requesting, by the registrar server, any one of the node servers to remit a quantity of digital coins corresponding to the authenticated payment information from a cryptocurrency wallet, included in the holding information of the cryptocurrency, to a cryptocurrency wallet, connected to the registrar server.

9. The method of claim 1, further comprising steps of:
requesting, by the registrar server, a cryptocurrency transaction intermediation server, connected to any one of the node servers, to transmit a market value of a digital coin;
receiving, by the registrar server, the market value of the digital coin from the cryptocurrency transaction intermediation server; and
requesting, by the registrar server, the cryptocurrency transaction intermediation server to sell some of or all of remaining quantities held in the cryptocurrency wallet, when a product of the market value and the quantity held in the cryptocurrency wallet is greater than a predetermined value.

10. The method of claim 9, further comprising steps of:
receiving, by the registrar server, a request to remit digital tokens whose transaction has been contracted from the cryptocurrency transaction intermediation server; and
requesting, by the registrar server, one or more of the node servers to remit a quantity of the digital coins whose remittance has been requested from the cryptocurrency wallet, included in the holding information of the cryptocurrency, to a target cryptocurrency wallet for which the remittance has been requested.

11. The method of claim 10, further comprising a step of storing, by the registrar server, a trading record of the digital coins whose remittance has been requested in a database of the registrar server.

12. The method of claim 1, wherein the holding information of the cryptocurrency is an address value of a cryptocurrency wallet.

13. The method of claim 12, further comprising a step of requesting, by the registrar server, one or more of the node servers to remit a predetermined quantity of digital coins from the cryptocurrency wallet, connected to the registrar server, to the cryptocurrency wallet corresponding to the address value included in the holding information of the cryptocurrency.

14. The method of claim 1, further comprising a step of requesting, by the registrar server, one or more of the node servers to record a data pair of the address of the domain and the holding information of the cryptocurrency.

15. The method of claim 1, further comprising steps of:
receiving, by the registrar server, a request to issue digital tokens the client of the domain owner; and
requesting, by the registrar server, one or more of the node servers to record the address of the domain and to issue the digital tokens.

16. The method of claim 1, wherein the holding information of the cryptocurrency is the holding information of at least one type of the cryptocurrency.

17. The method of claim 1, further comprising steps of:
receiving, by the registrar server, a question for registration information of the domain from a given client; and
transmitting, by the registrar server, a domain entity, comprising the address of the domain or the digital asset information, to the asked client.

18. A method of indexing, by a registry server, a domain to a digital asset, comprising steps of:
(a) receiving, by the registry server, a request for a registration of a domain entity from a registrar server; and
(b) recording, by the registry server, the requested registration of the domain entity in a database of the registry server;
wherein in the step (a), the domain entity whose registration has been requested by the registrar server comprises an address of a domain or digital asset information owned by an owner or owner-to-be of the domain, and
the digital asset information is holding information of cryptocurrency whose trading records of digital tokens are encrypted and connected to node servers over a network having a blockchain structure.

19. The method of claim 18, wherein:
in the step (a), the domain entity whose registration has been requested by the registrar server further comprises basic information of a company which is the owner or owner-to-be of the domain, and
the basic information is configured to comprise any one of pieces of information on a name, logo, name of a representative, date of establishment, form of business, corporate registration number, corporate body registration number, total assets, total ownership interest, total liability, total sales, business profits, net income, principal stockholders and board of directors of the company.

20. The method of claim 19, wherein:
in the step (a), the domain entity whose registration has been requested by the registrar server further comprises financial information of the company which is the owner or owner-to-be of the domain, and
the financial information comprises company information for financial statements of the company and an output of business activities of the company.

21. The method of claim 18, wherein the holding information of the cryptocurrency comprises an asset ID of a cryptocurrency wallet or a private key value to which a deposit and withdrawal authority has been assigned.

22. The method of claim 18, wherein the holding information of the cryptocurrency comprises an API key value to which a deposit and withdrawal authority for a cryptocurrency wallet has been assigned.

23. The method of claim 18, wherein the holding information of the cryptocurrency comprises a private key value or an API key value having a limited withdrawal authority for a cryptocurrency wallet.

24. The method of claim 21, further comprising steps of:
having, by the registry server, payment information authenticated by a client of the owner or owner-to-be of the domain or the registrar server; and
requesting, by the registry server, one or more of the node servers to remit a quantity of digital coins corresponding to the authenticated payment information from a cryptocurrency wallet, included in the holding information of the cryptocurrency, to a cryptocurrency wallet, connected to the registrar server or the registry server.

25. The method of claim 18, further comprising steps of:
requesting, by the registry server, a cryptocurrency transaction intermediation server, connected to any one of the node servers, to transmit a market value of a digital coin;
receiving, by the registry server, the market value of the digital coin from the cryptocurrency transaction intermediation server; and
requesting, by the registry server, the cryptocurrency transaction intermediation server to sell some of or all of remaining quantities held in the cryptocurrency wallet, when a product of the market value and the quantity held in the cryptocurrency wallet is greater than a predetermined value.

26. The method of claim 25, further comprising steps of:
receiving, by the registry server, a request to remit digital tokens whose transaction has been contracted from the cryptocurrency transaction intermediation server; and
requesting, by the registry server, one or more of the node servers to remit a quantity of the digital coins whose remittance has been requested from a cryptocurrency wallet, included in the holding information of the cryptocurrency, to a target cryptocurrency wallet for which the remittance has been requested.

27. The method of claim 26, further comprising a step of storing, by the registry server, a trading record of the digital coin whose remittance has been requested in a database of the registry server.

28. The method of claim 18, wherein the holding information of the cryptocurrency is an address value of a cryptocurrency wallet.

29. The method of claim 18, further comprising a step of requesting, by the registry server, one or more of the node servers to remit a predetermined quantity of digital coins from a cryptocurrency wallet, connected to the registry server, to a wallet corresponding to an address value of the cryptocurrency wallet.

30. The method of claim 18, further comprising a step of requesting, by the registry server, one or more of the node servers to record a data pair of the address of the domain and the holding information of the cryptocurrency.

31. The method of claim 18, further comprising steps of:
receiving, by the registry server, a request to issue digital tokens from a client of the domain owner; and
requesting, by the registry server, any one of the node servers to record the address of the domain and to issue the digital tokens.

32. The method of claim 18, wherein the holding information of the cryptocurrency is the holding information of at least one type of the cryptocurrency.

33. The method of claim 18, further comprising steps of:
receiving, by the registry server, a question for registration information of the domain from a given client or the registrar server; and
transmitting, by the registry server, a domain entity, comprising the address of the domain or the digital asset information, to the asked client or the registrar server.

34. The method of claim 6, further comprising steps of:
having, by the registrar server, payment information authenticated by the client of the owner or owner-to-be of the domain; and
requesting, by the registrar server, any one of the node servers to remit a quantity of digital coins corresponding to the authenticated payment information from a cryptocurrency wallet, included in the holding information of the cryptocurrency, to a cryptocurrency wallet, connected to the registrar server.

35. The method of claim 22, further comprising steps of:
having, by the registry server, payment information authenticated by a client of the owner or owner-to-be of the domain or the registrar server; and
requesting, by the registry server, one or more of the node servers to remit a quantity of digital coins corresponding to the authenticated payment information from a cryptocurrency wallet, included in the holding information of the cryptocurrency, to a cryptocurrency wallet, connected to the registrar server or the registry server.
